(19) United States
(12) Patent Application Publication
(10) Pub. No.: US 2017/0212990 A1
(43) Pub. Date: Jul. 27, 2017

(54) SYSTEM AND METHOD FOR OPTIMIZING ELECTRONIC MEDICAL TERMINOLOGY POST-COORDINATION CODING

(71) Applicant: Intelligent Medical Objects, Inc., Northbrook, IL (US)

(72) Inventors: Matthew Cardwell, Oak Park, IL (US); Steven Rube, Lake Forest, IL (US); Jose Maldonado, Chicago, IL (US); Regis Charlot, Lake Bluff, IL (US); Andrew Kanter, Highland Park, IL (US)

(21) Appl. No.: 15/006,635

(22) Filed: Jan. 26, 2016

(51) Int. Cl. G06F 19/00; G06F 17/30

(52) U.S. Cl. CPC G06F 19/322; G06F 17/30542

(57) ABSTRACT

A computer-implemented system and method for post-coordination of clinically relevant searches with respect to an electronic medical ontology includes mapping the searches to elements of the ontology, determining whether the mapped elements support post-coordination and, if not, relying on a hierarchy established by a second electronic medical ontology to which the first electronic medical ontology is mapped to determine whether one or more broader elements support post-coordination. Upon identifying one or more such broader elements, the system then may present the user with attribute selections associated with each element in order to obtain the desired post-coordination terms. The resulting combination of a broader element with its relevant attributes maps to a concept in the electronic medical ontology that is fully pre-coordinated with respect to a third electronic medical ontology.

### BACKGROUND

1. Field of the Invention

The present application is direct to a method and system for optimizing post-coordination coding with respect to one or more electronic medical ontologies.

2. Description of the Related Art

Electronic medical ontologies are necessary with the implementation and proliferation of electronic medical records. Various ontologies have been developed for various reasons, including administrative code sets that may be designed to support administrative functions of healthcare, such as reimbursement and other secondary data aggregation; clinical code sets that encode specific clinical entities involved in clinical work flow and allow for meaningful electronic exchange and aggregation of clinical data for better patient care; and reference terminology code sets that may be considered a “concept-based, controlled medical terminology” to maintain a common reference point in the healthcare industry. Reference terminologies also identify relationships between their concepts, e.g., relationships can be hierarchically defined, such as a parent/child relationship. Common examples of administrative code sets are the International Classification of Disease (ICD) and the Current Procedural Terminology, which is referred to via the trademark CPT. Examples of clinical code sets are the Logical Observation Identifiers Names and Codes, referred to under the trademark LOINC, and a normalized terminology for medication information, such as the terminology of the National Library of Medicine referred to under the trademark RxNorm. One example of a reference terminology is The Systematized Nomenclature of Medicine-Clinical Terms, referred to under the trademark “SNOMED CT.”

One challenge with implementing an electronic medical ontology is to ensure that a practitioner captures enough detail to adequately record a patient interaction and document the patient's history, problem list, medication list, etc. To do so, the practitioner would prefer to record terms that have semantic meaning, without being compelled to use rigid definitions or codes established by the relevant ontologies. One method of structuring and codifying the data to achieve this goal includes implementing an interface terminology that recognizes semantic meaning, mapping that interface terminology to the various other ontologies, and then relying on that interface terminology to analyze the practitioner's entries. One example of a system and method for using an interface terminology and the relevant ontology mappings may be found in the commonly-owned U.S. patent publication 2014/0122117, published May 1, 2014, the contents of which are incorporated by reference in their entirety. In that example, the interface terminology comprises a plurality of concepts within one or more domains, and one or more descriptions (lexicals) linked to each concept, where each description reflects an alternative way to express the concept.

One manner of selecting a desired term within a medical ontology is to use pre-coordination. A pre-coordinated term is one that has all of its necessary meaning contained within the term itself and does not need additional input from the user to be mapped to one or more ontologies. For example, the term “Type 2 diabetes mellitus without complications” may be a pre-coordinated term that, by itself, is descriptive enough to map to one or more ontologies. While the benefit of using pre-coordinated terms may be clear from a documentation and completeness standpoint, their efficient use also requires that the practitioner or coder knows each of the necessary terms and their constituent components. For an ontology like ICD-10-CM, which currently contains 68,000 codes, the likelihood of a practitioner knowing all necessary codes is virtually non-existent.

One alternative to pre-coordination is post-coordination, in which a user enters one or more base terms and then selects options from among one or more modifiers in order to drill down to a desired ontological code. One example of this process is described in the commonly-owned U.S. patent publication 2015/0154362, published Jun. 4, 2015.

Another example of the process may be seen in FIGS. 1-5, which illustrate a user entering a base term, here, “diabetes.” A system then presents the user with one or more descriptions that match, include, or otherwise are determined as being potentially relevant to the base term. Upon selecting one of those descriptions, the exemplary system may present the user with one or more categories of modifiers for the description, where exemplary classes of modifiers include laterality, anatomical site, severity, and one or more associated complications. As seen in the successive figures, selecting those modifiers ultimately leads the user to one or more ontological possibilities, guiding the user to the desired solution. One benefit of this process is that the user does not need to know the exact desired term but instead can work iteratively toward it.

On the downside, however, post-coordination relies on the user entering a valid initial query in order to populate the necessary options and their respective modifiers. If the user enters an initial query that is on a different branch of the hierarchy as the desired result or that may be clinically relevant but not important to the ontology being queried, then the user may not reach the most accurate ontological entry. Instead, the user may resort to a default entry, an entry that is incomplete, or an entry that does not match exactly with the patient's condition, which may result in an inaccurate patient record and/or the need to spend additional time or other resources to later remedy the situation. For example, as seen in FIG. 6, entering the word “uncontrolled” as part of the query may make sense from a clinician's point-of-view, because it helps to more accurately describe the patient's condition. At the same time, however, the phrase “uncontrolled type 1 diabetes” may not support post-coordination and/or may not represent a node in the desired electronic ontology, so the user may not be presented with any modifiers from which to select, thereby potentially confusing the user or leaving the user feeling that they have been penalized for adding what they thought was additional relevant information.

What are needed are a system and method that alleviate one or more of these drawbacks.

### BRIEF SUMMARY

In one aspect, a method includes the steps of: (1) receiving, by a computer, a user query corresponding to a clinical finding; (2) analyzing, by the computer, the query against a database containing a first electronic medical ontology to determine one or more exact or approximate matches to the query; and (3) determining, by the computer, whether the matches support post-coordination.

If a match supports post-coordination, the method includes: displaying a list of post-coordination attributes, receiving a user selection of one or more attributes, evaluating a combination of the match and the user-selected attributes against the database containing the first electronic medical ontology, presenting the user with a list of concepts in the first electronic medical ontology that include the match and the user-selected attributes, and receiving a user selection from the list of concepts. Conversely, if a match does not support post-coordination attributes, the method includes: searching, by the computer, for at least one term in the first electronic medical ontology that is broader than the match and that supports post-coordination, displaying a list of post-coordination attributes for the at least one term, receiving a user selection of one or more attributes, evaluating a combination of at least one term and the user-selected attributes against the database containing the first electronic medical ontology, presenting the user with a list of concepts in the first electronic medical ontology that include the at least one term and the user-selected attributes, and receiving a user selection from the list of concepts. In either case, the method also includes updating an electronic health record with data comprising the user query and a code value assigned to an element of a second electronic medical ontology, wherein the element of the second electronic medical ontology is mapped to the user selection from the list of concepts.

In another aspect, a method includes the steps of: receiving, by a computer, a user query corresponding to a clinical finding; mapping, by the computer, the user query to an element of a first electronic medical ontology; determining, by the computer, whether the element of the first electronic medical ontology supports post-coordination; if not, relying on a hierarchy established by a second electronic medical ontology to which the first electronic medical ontology is mapped to determine whether one or more broader elements support post-coordination; upon identifying at least one broader elements, presenting the user with attribute selections associated with the at least one broader element; and receiving a sufficient number of attribute selections to generate a fully pre-coordinated term.

### BRIEF DESCRIPTION OF THE SEVERAL VIEWS OF THE DRAWINGS

FIG. 1 is an exemplary screenshot of a first step in one method of post-coordination.

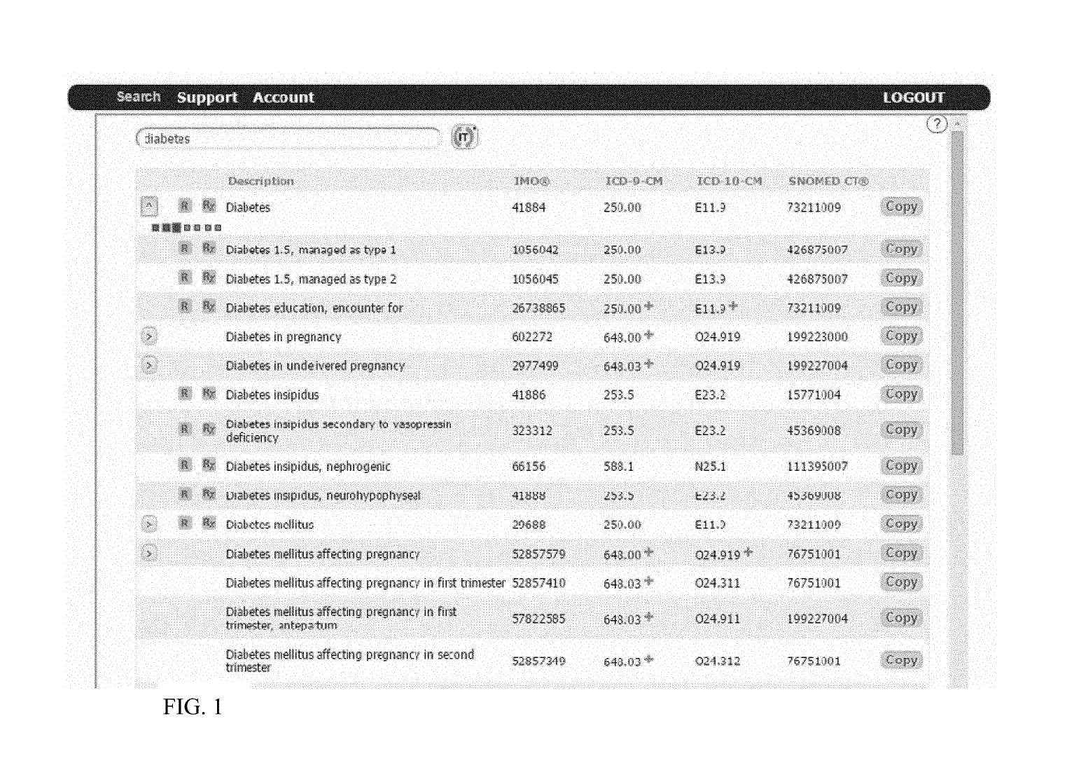

FIG. 2 is an exemplary screenshot of a second step in the method of post-coordination.

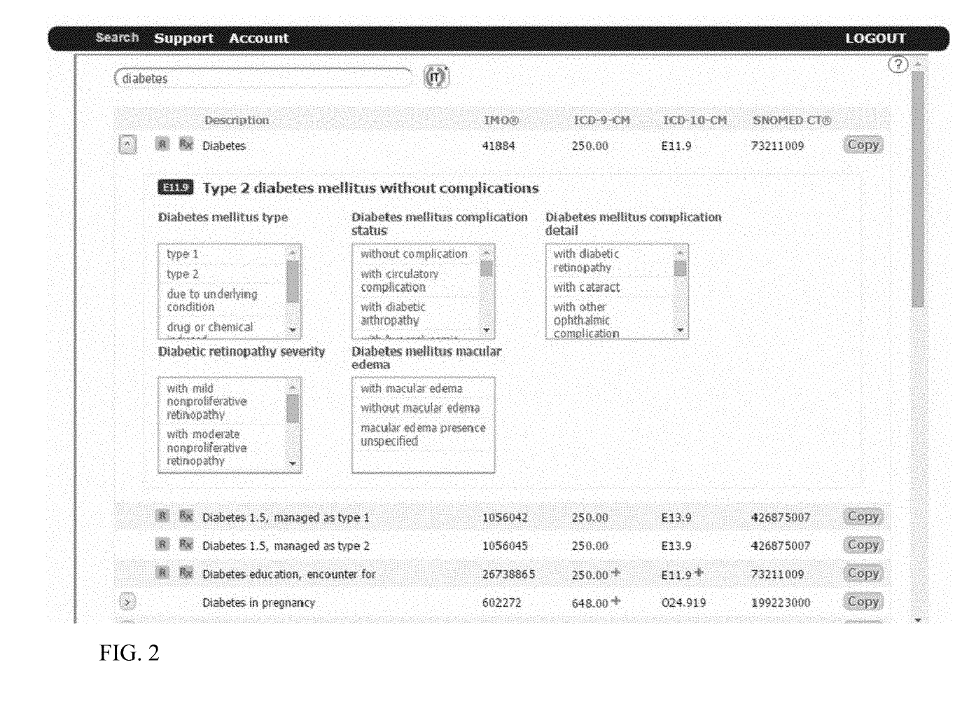

FIG. 3 is an exemplary screenshot of a third step in the method of post-coordination.

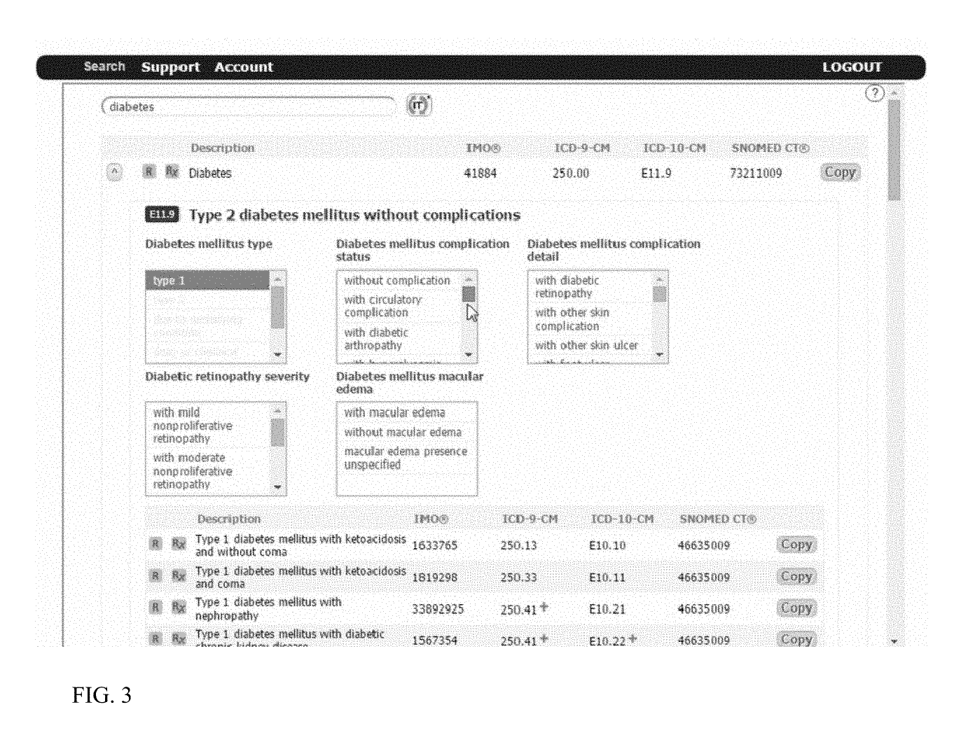

FIG. 4 is an exemplary screenshot of a fourth step in the method of post-coordination.

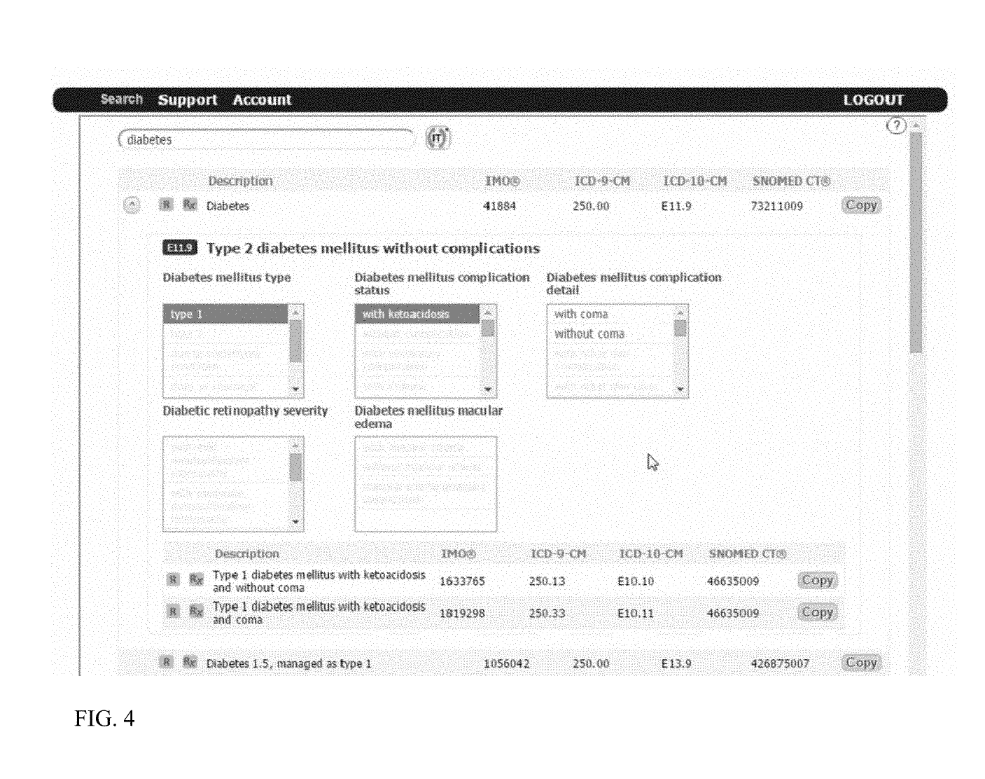

FIG. 5 is an exemplary screenshot of a fifth step in the method of post-coordination.

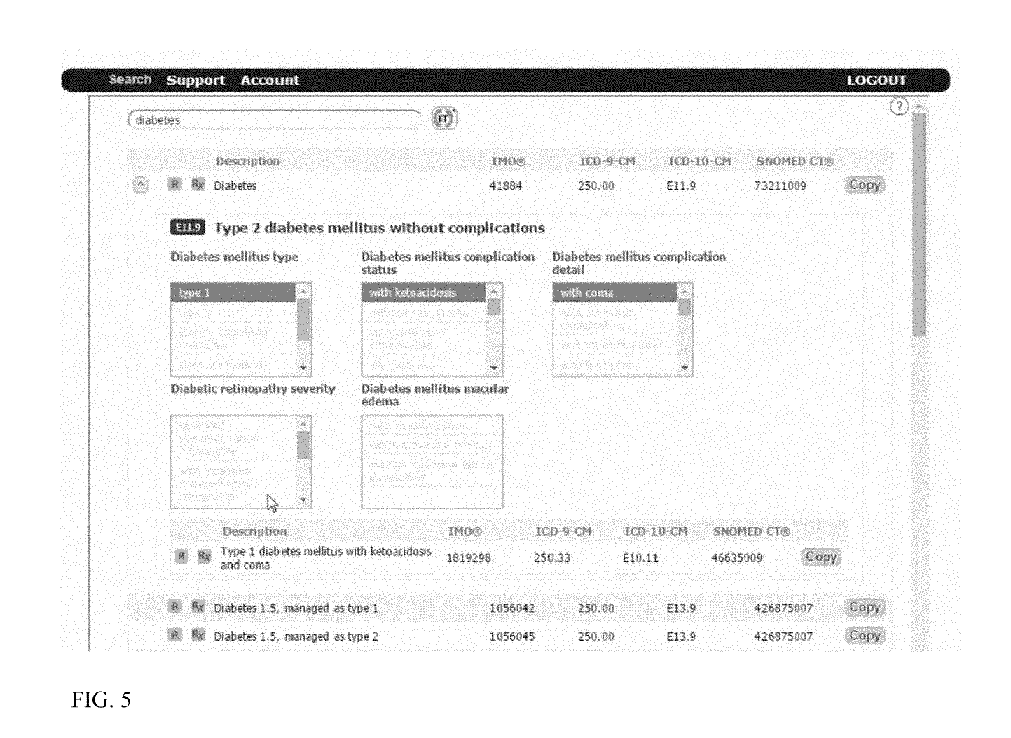

FIG. 6 is an exemplary screenshot of a query using the interface of FIG. 1 for a concept that does not support post-coordination.

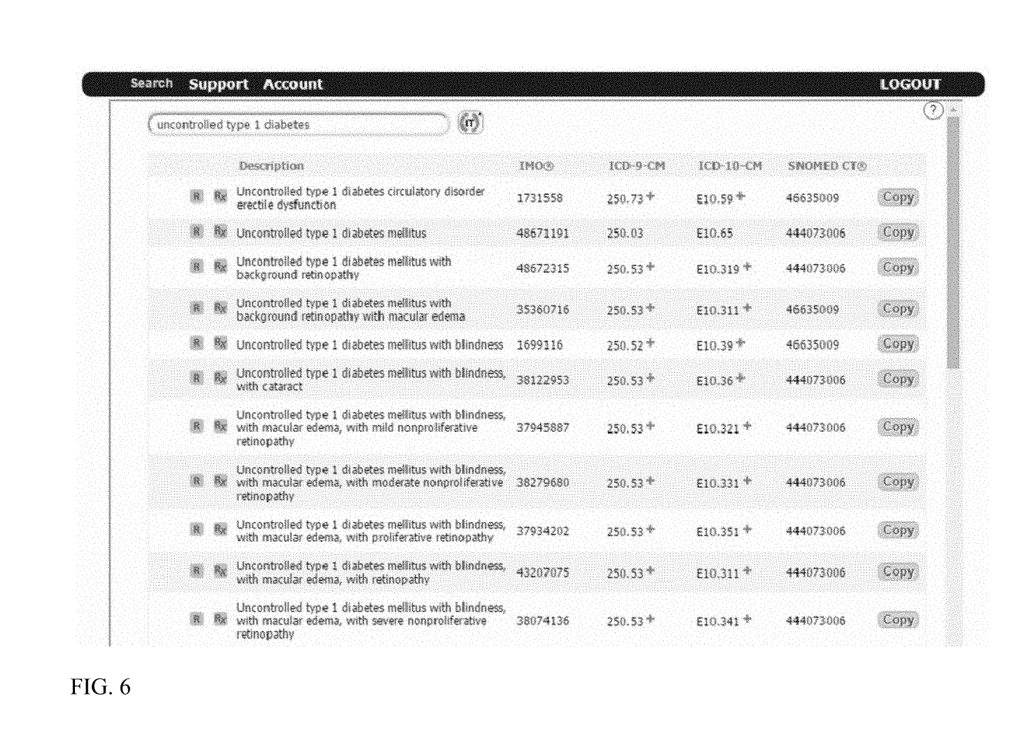

FIG. 7 is an exemplary screenshot of a user interface for post-coordinating terms related to a query to arrive at a pre-coordinated solution.

FIG. 8 is an example of a hierarchy among multiple elements within an electronic medical ontology, with elements within the ontology mapped to one or more elements within an additional external ontology.

FIG. 9 is an exemplary screenshot of the user interface of FIG. 7, depicting multiple post-coordination options to generate a pre-coordinated finding.

FIG. 10 is a table depicting various possibilities for hosting and implementing the system.

### DETAILED DESCRIPTION

With reference to the accompanying figures, a system and method to optimize post-coordination with respect to one or more electronic medical ontologies is disclosed. In one aspect, the system may be used to assist a user in obtaining another entry within the interface terminology and its respective ICD-10-CM code mapping, although the system also may be used with respect to one or more other ontologies, either directly or indirectly, through the implementation of an interface terminology mapped to entries in each ontology. In another aspect, the system analyzes user queries and, relying on comprehensive electronic terminology mappings, provides suggestions for further refinement to assist the user in determining a desired term. The process may resemble post-coordination, in that the system receives one or more additional user inputs to provide greater specificity, but the options presented to the user may be highly curated in order to land the user on a pre-coordinated description that, by itself, contains all the information necessary within that description and its related definition.

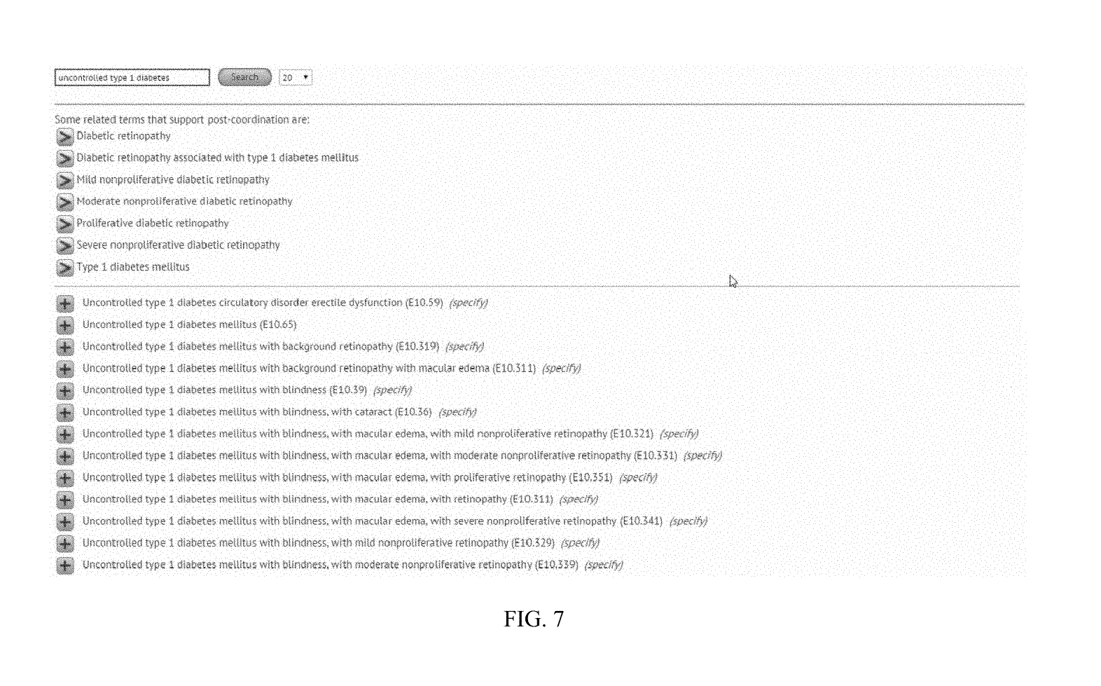

As seen in FIG. 7, in one aspect, the system receives a user input comprising a term to be mapped to an entry in an electronic medical ontology. In this regard, the word “term” may not be limited to a single word but instead may signify a word, a phrase, an acronym, an abbreviation, or any combination thereof. The system then may analyze the term to determine whether one or more concepts in an interface terminology include or otherwise match the term within a desired confidence level. Matches may be exact or approximate matches, and one or more methods for determining approximation may be used, as would be understood by one of ordinary skill in the art.

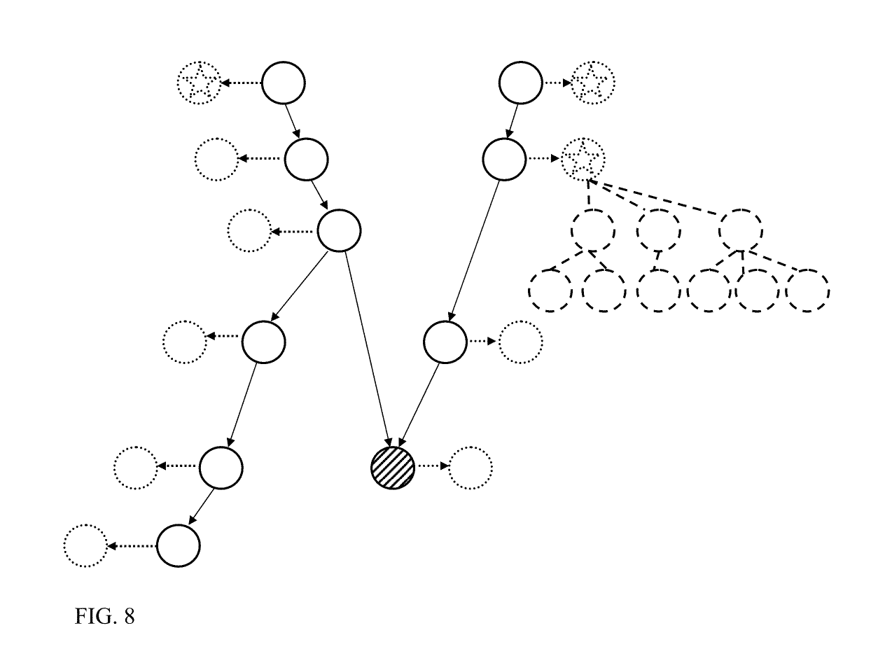

Interface terminology concepts may be related to one another hierarchically. Alternatively, however, concepts may be related semantically, while standing alone and not being related in a formal manner from an architecture standpoint, e.g., they may not be hierarchically related. In either case, each interface terminology element may map to an element in another ontology, e.g., a reference terminology code set element such as a SNOMED code set element. Those reference terminology elements may be hierarchically or otherwise formally grouped, and those groupings may be leveraged to generate groupings among multiple interface terminology elements. For example, FIG. 8 depicts one example of a hierarchy of elements in a reference terminology, where each element maps to a respective interface terminology element. In the figure, solid lines represent the reference terminology elements and hierarchy, and dotted lines represent the interface terminology elements and the mappings to the reference terminology elements. As this figure shows, the reference terminology may have a graph-type hierarchy, where child elements may have one or more than one parent elements.

Once the closest interface terminology concept match to the user's entry is determined, the system may determine whether that concept supports post-coordination using one or more attributes. Returning to the hierarchy example of FIG. 8, the central, hashed child node—or, more accurately, the dotted line node mapped to it—may represent the closest concept match to the user's entry. Interface terminology concepts supporting post-coordination are depicted in this figure by being starred and, in one example, post-coordination attributes are represented by the dashed-line elements extending from those starred concepts.

If the concept most closely matching the user's entry supports post-coordination, the system presents those post-coordination options to the user and receives the user's input of selected post-coordination attributes, cross-checking the combination of the concept with the selected attribute(s) and optionally presenting to the user a list of all interface terminology elements that match the combination. The system also may display references to one or more additional ontology elements mapped to those matching interface terminology elements, where the references may include, e.g., code values assigned to those additional ontology elements. As additional post-coordination attributes are selected and the number of matching interface terminology elements decreases, the system may remove or hide the non-matching elements or otherwise refresh the display to show only those elements that still match.

If the interface terminology concept most closely matching the user's entry does not support post-coordination, as in FIG. 8, the system may work backwards up the hierarchy (either the interface terminology hierarchy or the hierarchy established by another ontology that is mapped to the interface terminology concepts, as discussed above) to the next broadest interface terminology concept(s) to see whether post-coordination is supported at that level. In the event that the hierarchy branches, i.e., the previously-analyzed concept has or maps to more than one parent concept, the system may check both branches for a post-coordination-eligible map.

In one aspect, this process may repeat until the top of the hierarchy or a root node level has been reached, with the system keeping track of all entries that match the desired criteria on all branches that split from the search term node. This example is reflected by the system recording all three starred concepts in FIG. 8. The hierarchy may contain levels broader than a root node level, but the system may consider those levels too far unrelated to the user's query to be relevant.

In another aspect, the system may stop at whatever node level the first match is located and only keep track of matches at that level on each branch. Referring to FIG. 8, this example would be reflected by the system recording only the starred concept on the right-hand branch that is closest to the search term node.

In still another aspect, the system may determine which branch has the node with the match closest to the search term node and keep track of all matches on that branch only. Referring again to FIG. 8, this example would be reflected by the system recording all starred concepts on the right-hand branch.

In yet another aspect, the system may keep track of the node on each branch that is closest to the search term node. Referring once again to FIG. 8, this example would be reflected by the system recording the starred concept on the left-hand branch coming from the search term node and the lowermost starred concept on the right-hand branch coming from the search term node.

In each case, the same process may apply if the hierarchy branches upward at some node above the search term node, with that branching node being replaced as the point of reference for the options described above. In any event, the system also may not keep track of, and may not return, node results that correspond to concepts that do not support post-coordination.

In addition to keeping track of those potential post-coordination nodes, the system may display the concepts relating to those nodes to the user in order to receive a user selection of one of the nodes. Once selected, the system may display the appropriate post-coordination attributes for that concept to the user and progress to a final concept, as described above.

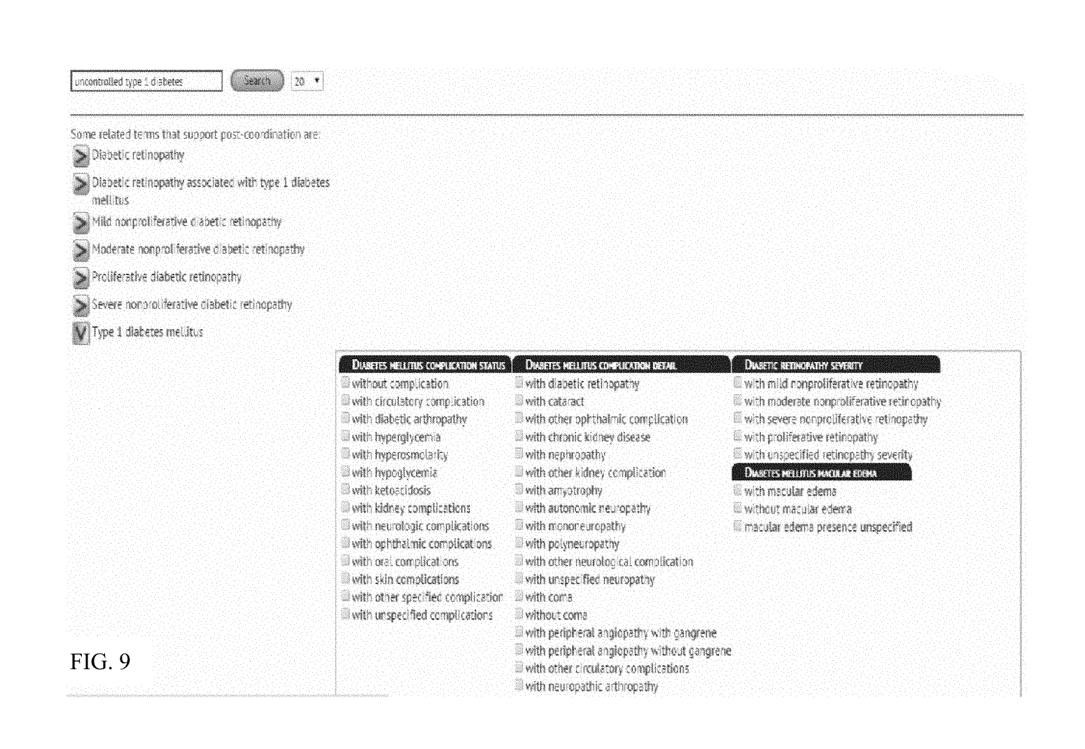

Returning to FIG. 7, one example of a user interface with a query that does not directly support post-coordination is depicted. In this example, the system may return two different categories of results. The first results, depicted as being preceded by carrot icons, correspond to concepts supporting post-coordination according to one or more of the methods discussed above. As seen in FIG. 9, selecting one of those results may launch one or more post-coordination categories of attributes. The system then may receive one or more user selections, which may cause the listing of attributes to be updated, e.g., by removing options that cannot pair with the already-selected attribute(s).

The second results, depicted as being preceded by plus signs, correspond to concepts that, at first, may appear to be more relevant based on closeness to the user's query but that, in reality, may be less useful because they do not support post-coordination. In some cases, such as the catch-all “Uncontrolled type I diabetes mellitus,” the result may be too general. Those results may be represented by non-starred nodes higher up in the hierarchy than the search term node of FIG. 8. In other cases, such as “Uncontrolled type I diabetes mellitus with background retinopathy with macular edema,” the result may be too specific. Those results may be represented by a non-starred search term node, or they may appear on parts of the hierarchy that branch off of a higher-up node, such as the leftmost branch in FIG. 8.

FIG. 8 depicts one example in which the user's query results in a single matching concept (corresponding to the search term node). Alternatively, the user's query may result in a plurality of matching concepts, where matches may be determined by having one or more words matching a word or words in the search, by using confidence intervals, or by using other techniques as would be appreciated by those of ordinary skill in the art. For example, each concept preceded by a plus sign in FIG. 7 may correspond to a search term node, and the methods described herein may be applied to the hierarchy relating to each such node.

Once the user selects the desired post-coordinated term, the system may record that ontological term and the code associated with it into the relevant patient's electronic medical record or electronic health record. One advantage of the present system is that the system also may record the user's search term as the related clinical finding, such that the patient's record reflects the physician's clinical intent. The post-coordinated term ultimately selected then may not be needed for maintaining a clinically relevant record but instead may be useful for other purposes. For example, the interface terminology term ultimately selected is mapped to an administrative terminology code system such as ICD-10-CM as well as a reference terminology like SNOMED, that administrative terminology code may be used to provide accurate billing requirements and the reference terminology code may be used to support Meaningful Use (Stage 2) compliance. At the same time, by retaining the user's entry within the patient's record, the system also maintains a clinically relevant finding.

Although mapping to an interface terminology has been described to this point with reference to a reference terminology, other mappings are possible, and experience suggests using whatever resources are available for finding the best concepts embedded in a given patient data set. Thus, the method may include building larger search sets of content from ICD-9-CM or ICD-10-CM, which require many of the same skills and, therefore, similar codes, for Meaningful Use (Stage 2).

System Configuration

The system may be accessible as a web-hosted service, preferably presenting the user with a thin client or portal with which to access the system, although a thick client implementation also is possible. Alternatively, the system may receive the various user inputs, analyze them, and return the resulting possible pre-coordinated terms and mappings between those terms and one or more electronic medical ontologies in dedicated data files.

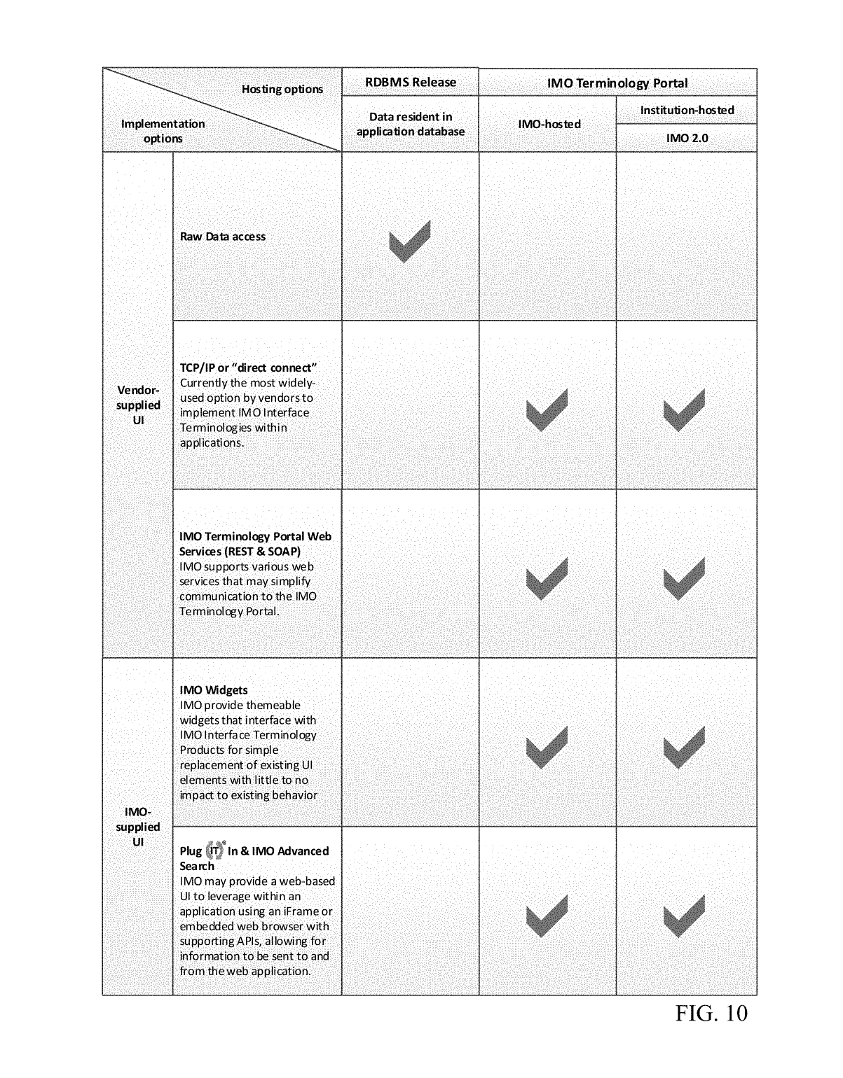

FIG. 10 depicts various exemplary ways in which the system may be hosted and implemented. The system may integrate with the end user's EHR software to provide an efficient platform for providing access to the relevant data while, at the same time, permitting the results to be stored within one or more patient records within the EHR.

In one aspect, the system may be hosted in a relational database management system (RDBMS) that can be located in various places, e.g., installed within the end user's internal systems or installed within the system operator's or vendor partner's systems and accessed remotely, with the latter configurations being preferred. In such an implementation, the user interface (UI) may be vendor-supplied and may be configured to receive, access, and format the relevant RDBMS raw data, with the vendor partner deciding specifically how to format queries and responses within its UI. Revisions to the RDBMS data may be compiled internally and pushed in one or more successive releases, e.g., at predetermined intervals, after a predetermined number of modifications to the RDBMS data have been made, or when a subjectively important enough modification has been made.

In another aspect, the system data may be accessed via a portal that may be internally hosted or externally hosted by the end user's institution. In either case, either a vendor-supplied UI or a data-generator-supplied UI may be relied upon to implement the methods described herein. When the UI is vendor supplied, the system may rely upon a direct connection, e.g., a TCP/IP connection to access the necessary data. Alternatively, the system may rely upon one or more web services specifically configured to communicate with the portal to receive and analyze the necessary data.

When the UI is data-generator-supplied and the data is hosted through a data-generator provided portal, implementation may be simplified because the UI may be designed specifically for such implementation. In that case, one or more themable widgets may be provided to integrate the necessary data into the UI with little to no impact on existing behavior or processing ability. Alternatively, the UI may be web-based or may include a web-based component as part of an application, and the relevant data may be transmitted through the web browser with supporting APIs.

In one aspect, the method may be executed by a system including a relational database, e.g., an Oracle or Microsoft SQL Server relational database. In an alternative aspect, data may be committed to a Cache database, which may be a hierarchical database providing for fast data storage and retrieval but relatively slower reporting needs such as data aggregation. In still another aspect, the method may be executed by a system employing a database such as an EPIC CLARITY database. The database may store one or more of: the reference terminology hierarchy, the mappings between elements of the hierarchy and elements of the interface terminology, post-coordination-type attributes associated with one or more of the interface terminology elements, and mappings between the interface terminology elements (and attributes) with one or more additional electronic medical ontologies (e.g., ICD-10-CM).

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

We claim:

1. A method, comprising:
(1) receiving, by a computer, a user query corresponding to a clinical finding;
(2) analyzing, by the computer, the query against a database containing a first electronic medical ontology to determine one or more exact or approximate matches to the query;
(3) determining, by the computer, whether the matches support post-coordination;
(4a) if a match supports post-coordination:
displaying a list of post-coordination attributes,
receiving a user selection of one or more attributes,
evaluating a combination of the match and the user-selected attributes against the database containing the first electronic medical ontology,
presenting the user with a list of concepts in the first electronic medical ontology that include the match and the user-selected attributes, and
receiving a user selection from the list of concepts; and
(4b) if a match does not support post-coordination attributes,
searching, by the computer, for at least one term in the first electronic medical ontology that is broader than the match and that supports post-coordination,
displaying a list of post-coordination attributes for the at least one term,
receiving a user selection of one or more attributes,
evaluating a combination of the at least one term and the user-selected attributes against the database containing the first electronic medical ontology,
presenting the user with a list of concepts in the first electronic medical ontology that include the at least one term and the user-selected attributes, and
receiving a user selection from the list of concepts; and
(5) updating an electronic health record with data comprising the user query and a code value assigned to an element of a second electronic medical ontology, wherein the element of the second electronic medical ontology is mapped to the user selection from the list of concepts in step (4a) or (4b).

2. The method according to claim 1, wherein the second electronic medical ontology is ICD-10.

3. The method according to claim 1, wherein the first electronic medical ontology is mapped to a third electronic medical ontology.

4. The method according to claim 3, wherein the third electronic medical ontology is the Systematized Nomenclature of Medicine-Clinical Terms.

5. The method according to claim 3, wherein the searching step is executed by analyzing a hierarchy established by elements of the third electronic medical ontology.

6. The method according to claim 1, wherein the searching step comprises analyzing a hierarchy mapped to the first electronic medical ontology and identifying each term in the first electronic medical ontology that is hierarchically broader than the match and that supports post-coordination, until at least a root node level is reached.

7. The method according to claim 1, wherein the searching step comprises analyzing a hierarchy mapped to the first electronic medical ontology, determining whether the hierarchy splits above the match into a plurality of branches, and identifying each term in the first medical ontology on each branch that supports post-coordination and that is closest to the match.

8. The method according to claim 1, wherein the searching step comprises analyzing a hierarchy mapped to the first electronic medical ontology, and the searching step terminates when a predetermined number of terms in the first electronic medical ontology that are broader than the match and that support post-coordination are identified.

9. The method according to claim 1, wherein the searching step comprises analyzing a hierarchy mapped to the first electronic medical ontology, determining whether the hierarchy splits above the match, and identifying at least one term in a plurality of branches above the split that is broader than the match and that supports post-coordination.

10. The method according to claim 1, wherein the searching step comprises analyzing a hierarchy mapped to the first electronic medical ontology, determining whether the hierarchy splits above the match, identifying a distance between the match and a closest term that supports post-coordination, and identifying other terms that support post-coordination that are spaced from the match by the distance.

11. The method according to claim 1, wherein the searching step comprises analyzing a hierarchy mapped to the first electronic medical ontology, determining whether the hierarchy splits above the match, identifying a closest term to the match that supports post-coordination, and identifying other terms that support post-coordination that are on a same branch as the closest term.

12. The method according to claim 1, wherein the user selection from the list of concepts in step (4a) or (4b) is fully pre-coordinated.

13. A method, comprising:
receiving, by a computer, a user query corresponding to a clinical finding;
mapping, by the computer, the user query to an element of a first electronic medical ontology;
determining, by the computer, whether the element of the first electronic medical ontology supports post-coordination;
if not, relying on a hierarchy established by a second electronic medical ontology to which the first electronic medical ontology is mapped to determine whether one or more broader elements support post-coordination;
upon identifying at least one broader elements, presenting the user with attribute selections associated with the at least one broader element; and
receiving a sufficient number of attribute selections to generate a fully pre-coordinated term.

14. The method according to claim 13, wherein the fully pre-coordinated term is pre-coordinated with respect to a third electronic medical ontology.

15. The method according to claim 14, wherein the third electronic medical ontology is ICD-10-CM.

16. The method according to claim 13, wherein the second electronic medical ontology is the Systematized Nomenclature of Medicine-Clinical Terms.

17. The method according to claim 13, wherein the second electronic medical ontology is an International Classification of Disease ontology.
